(19) United States
(12) Patent Application Publication
(10) Pub. No.: US 2025/0105417 A1
(43) Pub. Date: Mar. 27, 2025

(54) ENERGY STORAGE POWER FOLDABLE BRACKET

(71) Applicant: Guangdong Shunde Oured Technology Co.,Ltd, Foshan (CN)

(72) Inventors: LINGLI WEN, Foshan (CN); WEIGUANG LI, Foshan (CN)

(21) Appl. No.: 18/910,285

(22) Filed: Oct. 9, 2024

Related U.S. Application Data
(63) Continuation of application No. PCT/CN2024/087196, filed on Apr. 11, 2024.

(30) Foreign Application Priority Data
Sep. 22, 2023 (CN) 202322593828.X

(51) Int. Cl. H01M 50/244; H01M 50/262

(52) U.S. Cl. CPC H01M 50/244; H01M 50/262

(57) ABSTRACT

An energy storage power foldable bracket is provided, which includes a first bracket component for supporting a first support object, a second bracket component for supporting a second support object, and a plurality of telescopic rod components. The first bracket component is hinged to the telescopic rod components, the second bracket component is detachably provided on the plurality of telescopic rod components. When the second bracket component is provided on the plurality of telescopic rod components, a distance between the first bracket component and the second bracket component is adjusted by adjusting telescopic lengths of the telescopic rod components according to a height of the second support object to adapt to the second support with different heights. When the second bracket component is disassembled and separated from the plurality of telescopic rod components, each telescopic rod component is rotated and folded on the first bracket component.

### CROSS-REFERENCE TO RELATED APPLICATIONS

This application is a continuation of International Application No. PCT/CN2024/087196, filed on Apr. 11, 2024, which claims priority to Chinese Patent Application No. 202322593828.X, filed on Sep. 22, 2023, both of which are hereby incorporated by reference in their entireties.

### TECHNICAL FIELD

The present disclosure relates to the field of installation integrated machine for inverter and battery (power supply) technologies, and in particular, to an energy storage power foldable bracket.

### BACKGROUND

The existing power sources and inverters are stored separately, or they are installed on a same fixed housing for portability. For example, a portable photovoltaic energy storage structure is disclosed in CN 202211710651.0, which is used to fix an energy storage battery module, a charger, and an inverter in a housing; in this way, a user can only fix the battery module and the inverter, and cannot arrange another battery module and inverter according to his own needs. This structure is limited, and the battery module and the inverter are fixed in the housing, which is not convenient for disassembly and maintenance in a later stage.

### SUMMARY

The purpose of the present disclosure is to provide an energy storage power foldable bracket, which is provided with a first bracket component and a second bracket component to separately install and store an inverter and a power supply at intervals. When the inverter or the power supply is not needed, the second bracket component can be disassembled, and a telescopic rod component is folded on the first bracket component to save a storage space; when transporting the energy storage power foldable bracket, the telescopic rod component is folded onto the first bracket component, which can save a packaging cost.

The purpose of the present disclosure is achieved as follows.

An energy storage power foldable bracket, including a first bracket component configured to support a first support object, and a second bracket component configured to support a second support object, where the energy storage power foldable bracket further includes a plurality of telescopic rod components, the first bracket component is hinged to the plurality of telescopic rod components, and the second bracket component is detachably provided on the plurality of telescopic rod components;
when the second bracket component is provided on the plurality of telescopic rod components, a distance between the first bracket component and the second bracket component is adjusted by adjusting telescopic lengths of the plurality of telescopic rod components according to a height of the second support object;
when the second bracket component is disassembled and separated from the plurality of telescopic rod components, the plurality of telescopic rod components are hinged, rotated and folded on the first bracket component; or an independent bracket is formed by the first bracket component with the plurality of telescopic rod components, allowing a user to place an inverter or a power supply separately according to his needs.

In some embodiment of the present disclosure, the first bracket component includes two first longitudinal beams arranged at intervals, and two first transverse beams arranged at intervals; each of the two first longitudinal beams is provided with a first longitudinal adjustment groove, and the two first transverse beams are provided with a first longitudinal adjustment fixing structure; the two first transverse beams are supported on the two first longitudinal beams, and the first longitudinal adjustment fixing structure is inserted into the two first transverse beams and the first longitudinal adjustment groove; the two first transverse beams are slid back and forth on the two first longitudinal beams through the first longitudinal adjustment fixing structure and the first longitudinal adjustment groove; the two first transverse beams are fixed on the two first longitudinal beams through the first longitudinal adjustment fixing structure to adjust positions of the two first transverse beams on the two first longitudinal beams according to a length of the first support object so that first bracket component is capable of supporting the first support object with different lengths, the first support object is the inverter.

In some embodiment of the present disclosure, the two first transverse beams are provided with a first transverse adjustment groove configured for a fixing component being inserted, and the first support object is fixed on the two first transverse beams through the fixing component; a position of the fixing component on the first transverse adjustment groove is adjusted according to a width of the first support object, so that the first bracket component is capable of supporting the first support object with different widths.

In some embodiment of the present disclosure, the second bracket component includes two second longitudinal beams arranged at intervals, and two second transverse beams arranged at intervals, each of the two second transverse beams is provided with a plurality of limit pieces arranged at intervals, and the second support object is supported on the second bracket component and limited between the plurality of limit pieces in forward-backward, and/or left-right manner; each of the two second transverse beams is provided with a second longitudinal adjustment groove, and the plurality of limit pieces are provided with a second longitudinal adjustment fixing structure; the second longitudinal adjustment fixing structure is capable of being inserted into the plurality of limit pieces and the second longitudinal adjustment groove; the plurality of limit pieces are slid back and forth on the two second longitudinal beams through the second longitudinal adjustment fixing structure and the second longitudinal adjustment groove; the plurality of limit pieces are fixed on the two second longitudinal beams through the second longitudinal adjustment fixing structure to adjust positions of the plurality of limit pieces on the two second longitudinal beams according to a length of the second support object, so that the second bracket component is capable of supporting the second support object with different lengths; the second support object is the power supply.

In some embodiment of the present disclosure, each of the two second transverse beams is provided with a second transverse adjustment groove, each of the two second longitudinal beams is provided with a transverse adjustment fixing structure, the transverse adjustment fixing structure is capable of being inserted into the two second longitudinal beams and the second transverse adjustment groove, the two second longitudinal beams are slid back and forth on the two second transverse beams through the transverse adjustment fixing structure and the second transverse adjustment groove, and the two second longitudinal beams are fixed on the two second transverse beams through the transverse adjustment fixing structure to adjust positions of the two second longitudinal beams on the two second transverse beams according to a width of the second support object so that the second bracket component is capable of supporting the second support object with different widths.

In some embodiment of the present disclosure, the plurality of limit pieces include an adjustment seat connected with the second longitudinal adjustment fixing structure, the adjustment seat is provided with a first limit block, one end of the first limit block is provided with a second limit block; the second support object is limited between the plurality of limit pieces by the first limit block and/or the second limit block in forward-backward and/or left-right manner, a limit groove is formed between the first limit block and the second limit block of the plurality of limit pieces to limit a placement of the second support object.

In some embodiment of the present disclosure, the plurality of telescopic rod components include a fixed rod hinged to the first bracket component, and a movable rod connected to the second bracket component; the fixed rod is provided with a telescopic cavity and a plurality of adjustment fixing positions at different positions, and the adjustment fixing positions are communicated with the telescopic cavity; the movable rod is provided with a groove chamber configured to accommodate and install a telescopic adjustment locking piece; the telescopic adjustment locking piece includes a first shrapnel and a first pin provided on the first shrapnel; the movable rod is provided with an insertion hole communicated with the groove chamber; one end of the first shrapnel is elastically abutted against the groove chamber, and the first pin is extended out of the insertion hole through the other end of the first shrapnel;
when the movable rod is inserted into the telescopic cavity of the fixed rod, the first pin is pressed and retracted into the groove chamber of the movable rod, after the movable rod is inserted into a corresponding position, the insertion hole corresponds to one of the adjustment fixing positions, the first pin is extended out of the insertion hole and the adjustment fixing positions under an action of the first shrapnel, so that the movable rod is fixed on the fixed rod.

In some embodiment of the present disclosure, a rotating connection component is provided between the first bracket component and the plurality of telescopic rod components, the rotating connection component includes a first connection piece fixedly connected to the first bracket component, and a second connection piece fixedly connected to the plurality of telescopic rod components, the second connection piece is rotatably connected to the first connection piece through a rotation shaft; the first connection piece is provided with an angle adjustment groove, and the angle adjustment groove is provided with an angle adjustment locking piece; the second connection piece is rotated on the first connection piece through a rotation shaft, one end of the angle adjustment locking piece is inserted into the angle adjustment groove and abutted against the second connection piece to fix the second connection piece that has been rotated on the first connection piece.

In some embodiment of the present disclosure, the plurality of telescopic rod components include a movable rod, the second bracket component includes a second transverse beam, the second transverse beam is provided with a clamp slot and a fixed hole, the movable rod is provided with a groove chamber configured to accommodate and install a limit shaft and an elastic fastener; the movable rod is provided with a perforation configured for the limit shaft being inserted; the elastic fastener includes a second shrapnel, and a second pin provided on the second shrapnel, one end of the second shrapnel abuts against the groove chamber, and the movable rod is provided with a connection hole;
when the second bracket component is provided on the plurality of telescopic rod components, the clamp slot of the second transverse beam is supported on the limit shaft; the second pin is extended through the connection hole and the fixed hole through the other end of the second shrapnel so as to fix the second transverse beam of the second bracket component on the movable rod of the plurality of telescopic rod components;
when disassembling the second bracket component and the plurality of telescopic rod components, the second pin is put into the connection hole by pressing the second pin, and the clamp slot of the second transverse beam is disengaged from the limit shaft so as to achieve a disassembly of the second bracket component on the plurality of telescopic rod components. Which is convenience to disassemble and assemble the second bracket component.

In some embodiment of the present disclosure, bottoms of the plurality of telescopic rod components are provided with a caster, rendering it easy for the user to move and carry the energy storage power foldable bracket.

The beneficial effects of the present disclosure are as follows.

With more and more people using market batteries and inverters for travel and self-driving, but the specifications are not uniform, rendering the installation efficiency is low. Therefore, an energy storage power foldable bracket is provided for market battery (power supply) specifications and inverter specifications. Through the above structure, the first bracket component can support inverters with different specifications and sizes, and the second bracket component can support the power supplies with different specifications and sizes. Furthermore, the inverters and power supplies can be separately installed and stored on the energy storage power foldable bracket, it is easy disassembly, maintenance, and upkeep in a later stage.

### BRIEF DESCRIPTION OF DRAWINGS

FIG. 1 is an opening schematic structural diagram of an energy storage power foldable bracket according to an embodiment of the present disclosure.

FIG. 2 is a schematic structural diagram of the energy storage power foldable bracket in a folded state according to an embodiment of the present disclosure.

FIG. 3 is a schematic structural diagram of assembly and disassembly of the energy storage power foldable bracket according to an embodiment of the present disclosure.

FIG. 4 is a cross-sectional schematic structural diagram of the energy storage power foldable bracket according to an embodiment of the present disclosure.

FIG. 5 is a schematic structural diagram of the energy storage power foldable bracket in another folded state according to an embodiment of the present disclosure.

FIG. 6 is an enlarged schematic structural diagram at point C in FIG. 5.

FIG. 7 is a schematic structural diagram of a rotating connection component according to an embodiment of the present disclosure.

FIG. 8 is a schematic structural diagram of an assembly of a second bracket component and a telescopic rod component in an embodiment of the present disclosure.

FIG. 9 is a schematic structural diagram of the assembly and disassembly of the second bracket component and the telescopic rod component in an embodiment of the present disclosure.

FIG. 10 is a schematic structural diagram of an inverter and a power source that are integrated installation in an embodiment of the present disclosure.

### DESCRIPTION OF EMBODIMENTS

The present disclosure will be further described in combination with the accompanying drawings and embodiments.

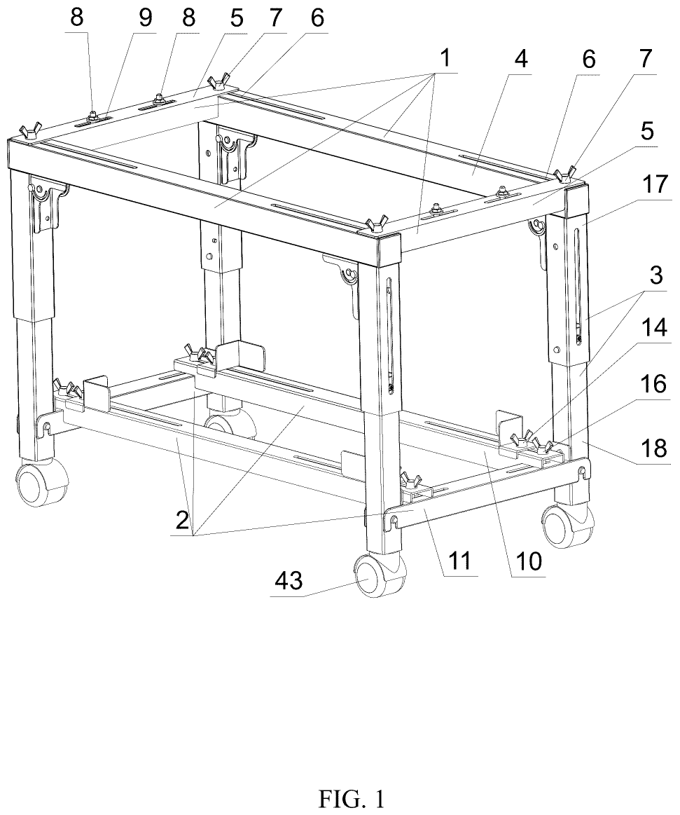

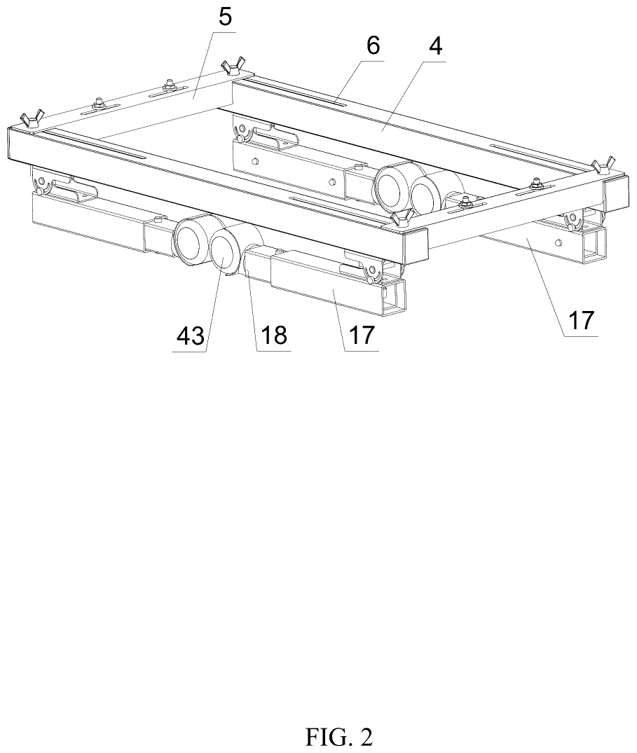

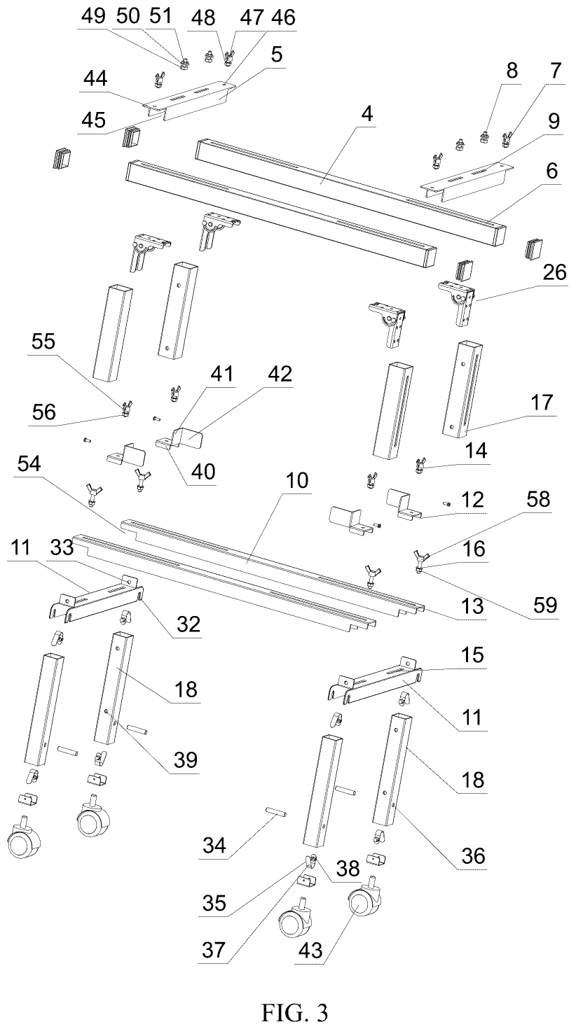

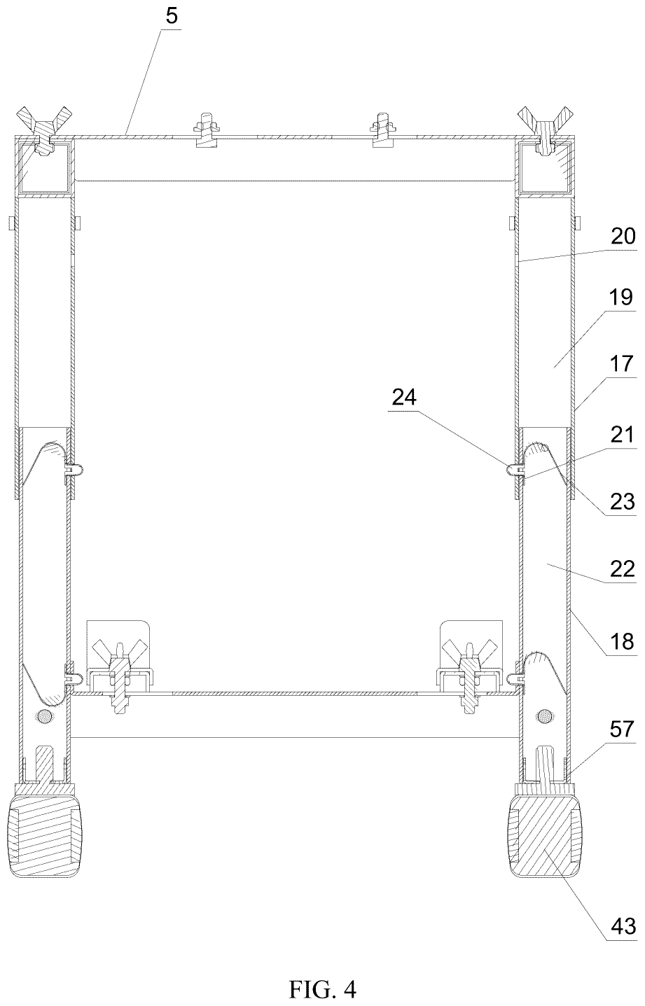

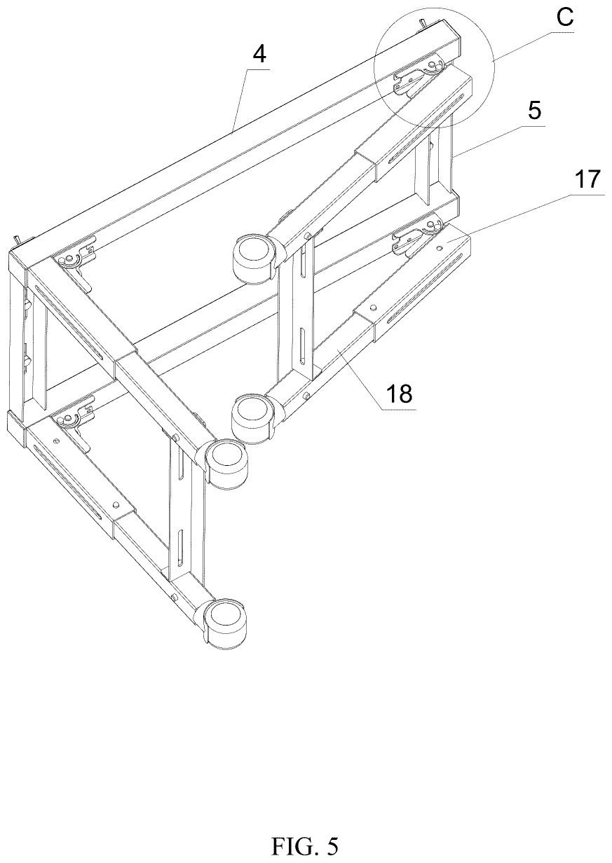

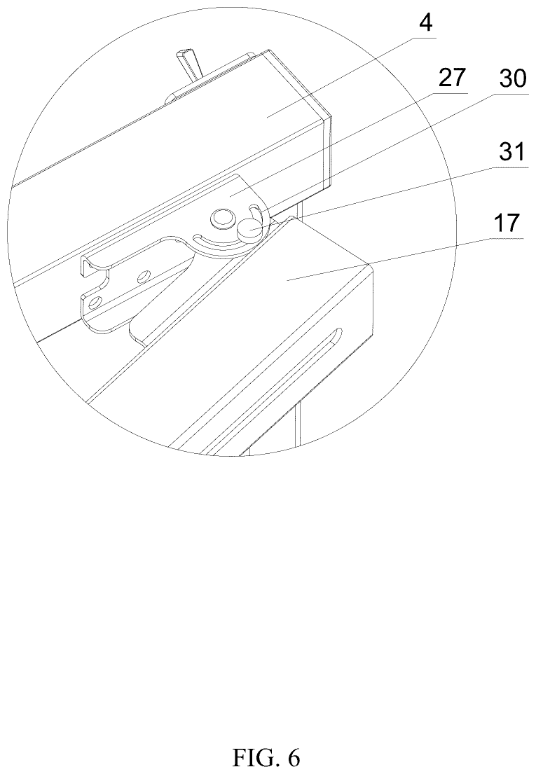

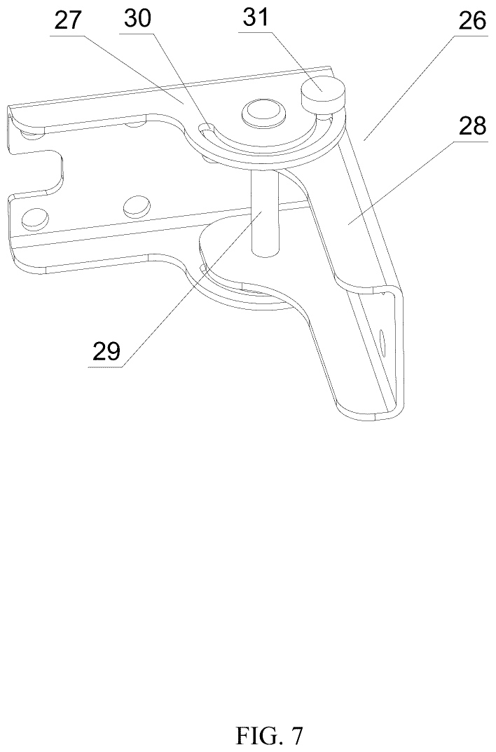

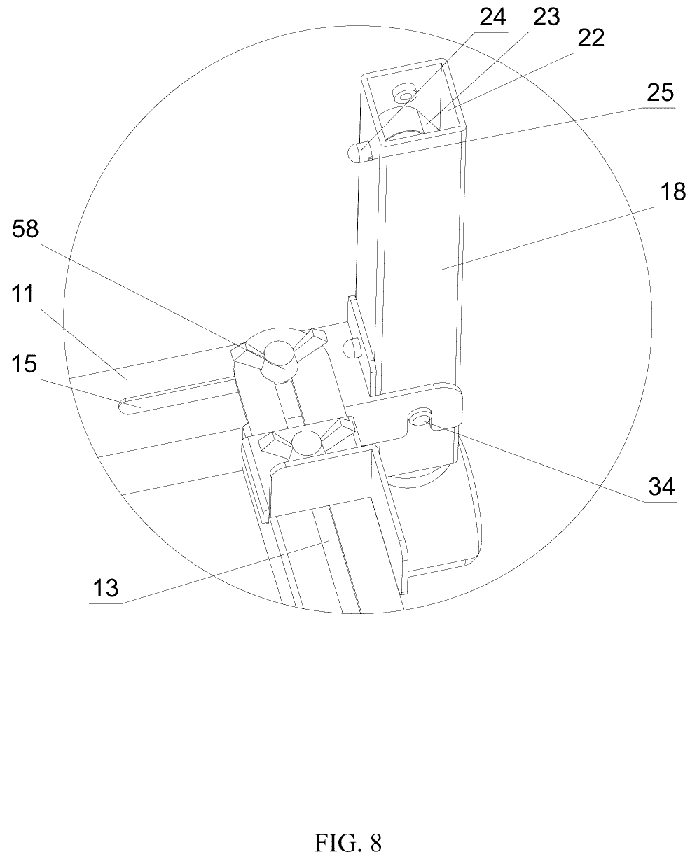

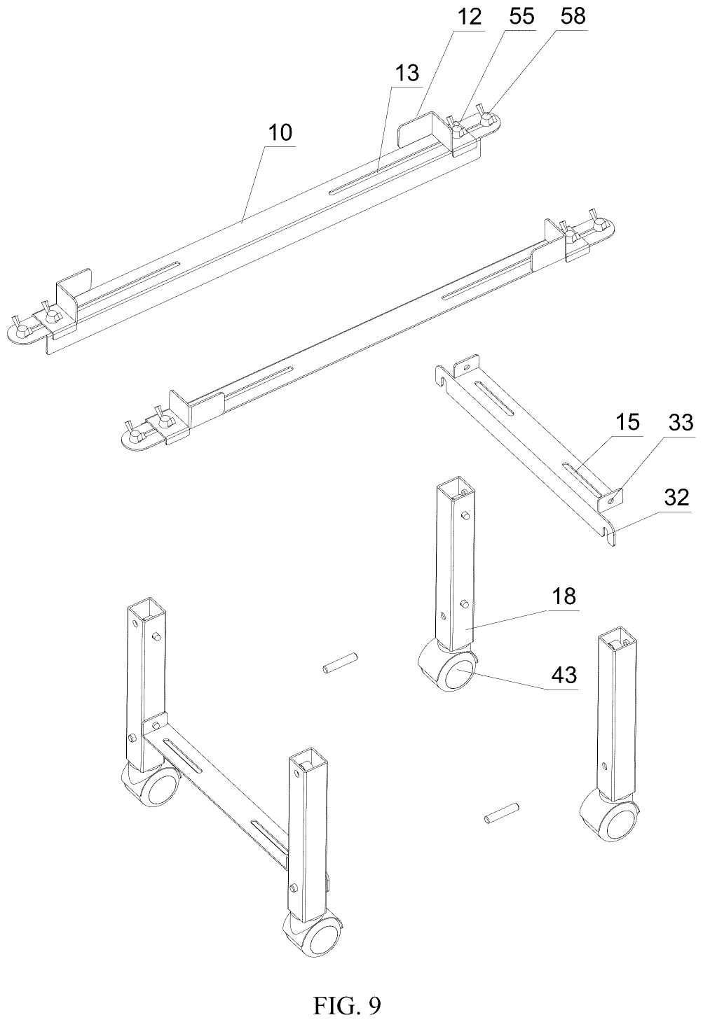

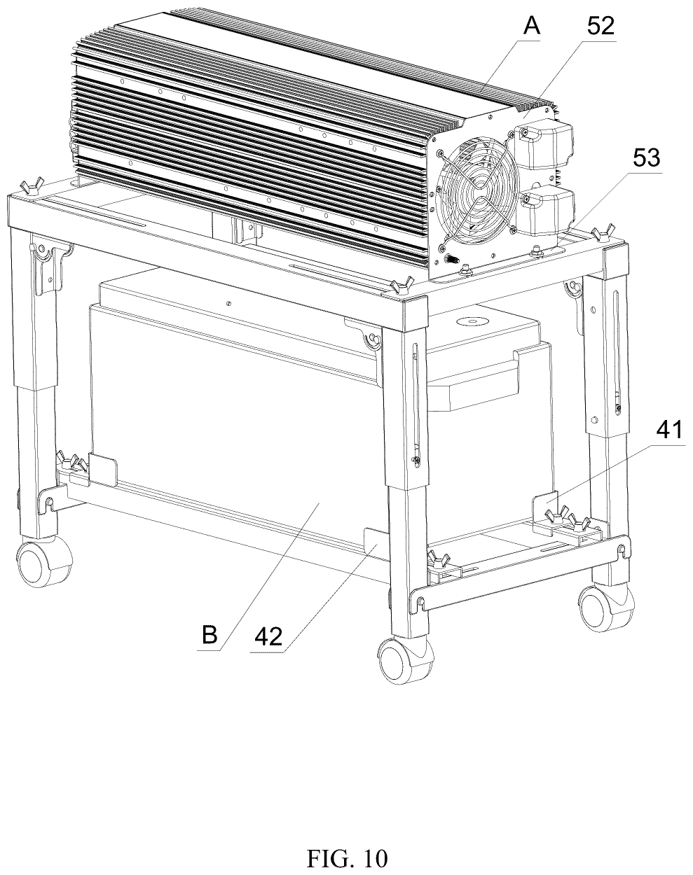

Referring to FIGS. 1-10, an energy storage power foldable bracket includes a first bracket component 1 configured to support a first support object A, and a second bracket component 2 configured to support a second support object B, and further includes a plurality of telescopic rod components 3; the first bracket component 1 is hinged to the plurality of telescopic rod components 3, and the second bracket component 2 is detachably provided on the plurality of telescopic rod components 3;
when the second bracket component 2 is provided on the plurality of telescopic rod components 3, a distance between the first bracket component 1 and the second bracket component 2 is adjusted by adjusting telescopic lengths of the plurality of telescopic rod components 3 according to a height of the second support B;
when the second bracket component 2 is disassembled and separated from the plurality of telescopic rod components 3, the plurality of telescopic rod components 3 are hinged, rotated, and folded on the first bracket component 1; or an independent bracket is formed by the first bracket component 1 and the plurality of telescopic rod components 3.

The first bracket component 1 includes two first longitudinal beams 4 arranged at intervals, and two first transverse beams 5 arranged at intervals; each of the two first longitudinal beams 4 is provided with a first longitudinal adjustment groove 6, and the two first transverse beams 5 are provided with a first longitudinal adjustment fixing structure 7. The two first transverse beams 5 are supported on the two first longitudinal beams 4, and the first longitudinal adjustment fixing structure 7 is inserted into the two first transverse beams 5 and the first longitudinal adjustment groove 6. The two first transverse beams 5 are slid back and forth on the two first longitudinal beams 4 through the first longitudinal adjustment fixing structure 7 and the first longitudinal adjustment groove 6. The two first transverse beams 5 are fixed on the two first longitudinal beams 4 through the first longitudinal adjustment fixing structure 7 to adjust positions of the two first transverse beams 5 on the two first longitudinal beams 4 according to a length of the first support object A, so that the first bracket component 1 can support the first support object A with different lengths, the first support object A is an inverter.

The two first transverse beams 5 are provided with a first transverse adjustment groove 9 configured for a fixing component 8 being inserted. The first support A is fixed to the two first transverse beams 5 through the fixing component 8, and a position of the fixing component 8 on the first transverse adjustment groove 9 is adjusted according to a width of the first support A, so that the first bracket component 1 can support the first support A with different widths.

In this embodiment, the two first transverse beams 5 are provided with a support block 44 at two ends that are supported on the two first longitudinal beams 4. Corresponding to the support block 44 on the two first transverse beams 5, there is a support avoidance gap 45. The support block 44 is provided with a first adjustment fixed hole 46 corresponding to the first longitudinal adjustment fixing structure 7 and the first longitudinal adjustment groove 6. The first longitudinal adjustment fixing structure 7 includes a first adjustment bolt 47 and a first adjustment nut 48. The first adjustment bolt 47 is inserted into the first adjustment fixed hole 46 and the first longitudinal adjustment groove 6. The first adjustment nut 48 and the first adjustment bolt 47 lock and fix the two first transverse beams 5 on the first longitudinal adjustment groove 6 of the two first longitudinal beams 4. When adjusting positions of the two first transverse beams 5 on the two first longitudinal beams 4, the first adjustment bolt 47 is twisted, and the two first transverse beams 5 are slid longitudinally along the first longitudinal adjustment groove 6, and the two first transverse beams 5 are slid to corresponding positions, the first adjustment bolt 47 is twist again to fix the two first transverse beams 5 on the two first longitudinal beams 4 so as to adjust a distance between the two first transverse beams 5 of the first bracket component 1.

In this embodiment, the fixing component 8 includes a first fixed bolt 49, a first gasket 50, and a first fixed nut 51. A fixed fitting 52 is provided on the first support object A, and a bend block 53 is provided on the fixed fitting 52. The bend block 53 is supported on the two first transverse beams 5 and has an installation gap. The first fixed bolt 49 is limited to the installation gap, the bend block 53 is pressed onto the two first transverse beams 5 by the first fixed nut 51 and the first gasket 50 so as to disassemble and fix the first support A onto the first bracket component 1.

The second bracket component 2 includes two second longitudinal beams 10 arranged at intervals, and two second transverse beams 11 arranged at intervals. Each of the two second transverse beams 11 is provided with a plurality of limit pieces 12 arranged at intervals. The second support B is supported on the second bracket component 2 and is limited between the plurality of limit pieces 12 in forward-backward, and/or left-right manner. Each of the two second transverse beams 11 is provided with a second longitudinal adjustment groove 13, and the plurality of limit pieces 12 are provided with a second longitudinal adjustment fixing structure 14. The second longitudinal adjustment fixing structure 14 is inserted into the plurality of limit pieces 12 and the second longitudinal adjustment groove 13. The plurality of limit pieces 12 are slid back and forth on the two second longitudinal beams 10 through the second longitudinal adjustment fixing structure 14 and the second longitudinal adjustment groove 13. The plurality of limit pieces 12 are fixed on the two second longitudinal beams 10 through the second longitudinal adjustment fixing structure 14 to adjust positions of the plurality of limit pieces 12 on the two second longitudinal beams 10 according to a length of the second support B, so that the second bracket component 2 can support the second support B with different lengths, the second support B is a power source.

Each of the two second transverse beam 11 is provided with a second transverse adjustment groove 15, and each of the two second longitudinal beams 10 is provided with a transverse adjustment fixing structure 16. The transverse adjustment fixing structure 16 passes through the two second longitudinal beams 10 and the second transverse adjustment groove 15. The two second longitudinal beams 10 are slid back and forth on the two second transverse beams 11 through the transverse adjustment fixing structure 16 and the second transverse adjustment groove 15. The two second longitudinal beams 10 are fixed on the two second transverse beams 11 through the transverse adjustment fixing structure 16 to adjust positions of the two second longitudinal beams 10 on the two second transverse beams 11 according to a width of the second support B, so that the second bracket component 2 can support the second support B with different widths.

In this embodiment, each of the two second longitudinal beams 10 is provided with a support gap 54, and the two second longitudinal beams 10 are supported on the two second transverse beams 11 through the support gap 54. The second longitudinal adjustment fixing structure 14 includes a second adjustment bolt 55 and a second adjustment nut 56, and the plurality of limit pieces 12 are fixed on the two second longitudinal beams 10 through the second adjustment bolt 55 and the second adjustment nut 56. Positions of the plurality of limit pieces 12 on the two second longitudinal beams 10 are adjusted by twisting the second adjustment bolt 55.

The plurality of limit pieces 12 includes an adjustment seat 40 that is connected to the second longitudinal adjustment fixing structure 14. The adjustment seat 40 is provided with a first limit block 41, one end of the first limit block 41 is provided with a second limit block 42. The second support B is limited between the plurality of limit pieces 12 by the first limit block 41 and/or the second limit block 42 in forward backward and/or left-right manner, and a limit groove is formed between the first limit block 41 and the second limit block 42 of the plurality of limit pieces 12 to limit a placement of the second support B.

In this embodiment, the transverse adjustment fixing structure 16 includes a third adjustment bolt 58 and a third adjustment nut 59, and the two second longitudinal beams 10 are adjusted and fixed on the two second longitudinal beams 10 through the third adjustment bolt 58 and the third adjustment nut 59.

The plurality of telescopic rod components 3 include a fixed rod 17 hinged to the first bracket component 1, and a movable rod 18 connected to the second bracket component 2. The fixed rod 17 is provided with a telescopic cavity 19 and a plurality of adjustment fixing positions 20 at different positions that are communicated with the telescopic cavity 19. The movable rod 18 is provided with a groove chamber 22 for accommodating and installing the telescopic adjustment locking piece 21. The telescopic adjustment locking piece 21 includes a first shrapnel 23 and a first pin 24 provided on the first shrapnel 23. The movable rod 18 is provided with an insertion hole 25 communicated with the groove chamber 22. One end of the first shrapnel 23 is elastically abutted against the groove chamber 22, and the first pin 24 is extended out of the insertion hole 25 through the other end of the first shrapnel 23;
when the movable rod 18 is inserted into the telescopic cavity 19 of the fixed rod 17, the first pin 24 is squeezed and retracted into the groove chamber 22 of the movable rod 18. After the movable rod 18 is inserted into a corresponding position, the insertion hole 25 corresponds to one of the adjustment fixing positions 20, the first pin 24 is extended out of the insertion hole 25 and the adjustment fixing position 20 under an action of the first shrapnel 23, so that the movable rod 18 is fixed to the fixed rod 17.

A rotating connection component 26 is provided between the first bracket component 1 and the plurality of telescopic rod components 3. The rotating connection component 26 includes a first connection piece 27 fixedly connected to the first bracket component 1, and a second connection piece 28 fixedly connected to the plurality of telescopic rod components 3. The second connection piece 28 is rotatably connected to the first connection piece 27 through a rotation shaft 29. The first connection piece 27 is provided with an angle adjustment groove 30, which is provided with an angle adjustment locking piece 31. The second connection piece 28 is positioned and rotated on the first connection piece 27 through the rotation shaft 29. One end of the angle adjustment locking piece 31 is inserted into the angle adjustment groove 30 and abutted against the second connection piece 28 to fix the second connection piece 28 that has been rotated on the first connection piece 27.

In this embodiment, the angle adjustment groove 30 is arc-shaped or bent, and the first connection piece 27 is fixedly connected to the two first longitudinal beams 4 through a screw. The fixed rod 17 of the plurality of telescopic rod components 3 is fixedly connected to the second connection piece 28 through a screw.

In this embodiment, a plurality of arc-shaped angle adjustment holes are provided on the second connection piece 28 corresponding to the angle adjustment groove 30. The angle adjustment locking piece 31 is inserted into the angle adjustment holes and the angle adjustment groove 30 for locking and fixing. This locking and fixing way can be combined with a nut for locking and fixing.

The plurality of telescopic rod components 3 include a movable rod 18, and the second bracket component 2 includes a second transverse beam 11. The second transverse beam 11 is provided with a clamp slot 32 and a fixed hole 33; the movable rod 18 is provided with a groove chamber 22 for accommodating and installing a limit shaft 34 and an elastic fastener 35; the movable rod 18 is provided with a perforation 36 for a limit shaft 34 being inserted; the elastic fastener 35 includes a second shrapnel 37 and a second pin 38 provided on the second shrapnel 37; one end of the second shrapnel 37 is connected to the groove chamber 22, and a connection hole 39 is provided on the movable rod 18;
when the second bracket component 2 is provided on the plurality of telescopic rod components 3, the clamp slot 32 of the second transverse beam 11 is supported on the limit shaft 34; the second pin 38 is extended through the connection hole 39 and the fixed hole 33 by the other end of the second shrapnel 37 so as to fix the second transverse beam 11 of the second bracket component 2 to the movable rod 18 of the plurality of telescopic rod components 3;
when disassembling the second bracket component 2 and the plurality of telescopic rod component 3, the second pin 38 is pressed into the connection hole 39 by pressing the second pin 38, and the clamp slot 32 of the second transverse beam 11 is disengaged from the limit shaft 34 so as to achieve a disassembly of the second bracket component 2 on the plurality of telescopic rod components 3.

Bottoms of the plurality of telescopic rod components 3 are provided with a caster 43.

In this embodiment, a bottom of the groove chamber 22 of the movable rod 18 is provided with an installation block 57, which is provided with a bolt connection hole. The caster 43 is provided with a fixed bolt for the bolt connection hole been inserted into.

The above is the preferred solution of the present disclosure, which displays and describes the basic principles, main features, and advantages of the present disclosure. Those skilled in the art should understand that the present disclosure is not limited by the above embodiments. The above embodiments and the description in the specification only illustrate the principles of the present disclosure. Without departing from the spirit and scope of the present disclosure, there may be various changes and improvements to the present disclosure, which fall within the scope of the present disclosure. The protection scope of required by the present disclosure is defined by the attached claims and their equivalents.

What is claimed is:

1. An energy storage power foldable bracket, comprising a first bracket component configured to support a first support object, and a second bracket component configured to support a second support object,
wherein the energy storage power foldable bracket further comprises a plurality of telescopic rod components, the first bracket component is hinged to the plurality of telescopic rod components, and the second bracket component is detachably provided on the plurality of telescopic rod components;
when the second bracket component is provided on the plurality of telescopic rod components, a distance between the first bracket component and the second bracket component is adjusted by adjusting telescopic lengths of the plurality of telescopic rod components according to a height of the second support object;
when the second bracket component is disassembled and separated from the plurality of telescopic rod components, the plurality of telescopic rod components are hinged, rotated and folded on the first bracket component; or an independent bracket is formed by the first bracket component with the plurality of telescopic rod components.

2. The energy storage power foldable bracket according to claim 1, wherein the first bracket component comprises two first longitudinal beams arranged at intervals, and two first transverse beams arranged at intervals;
each of the two first longitudinal beams is provided with a first longitudinal adjustment groove, and the two first transverse beams are provided with a first longitudinal adjustment fixing structure;
the two first transverse beams are supported on the two first longitudinal beams, and the first longitudinal adjustment fixing structure is inserted into the two first transverse beams and the first longitudinal adjustment groove;
the two first transverse beams are slid back and forth on the two first longitudinal beams through the first longitudinal adjustment fixing structure and the first longitudinal adjustment groove;
the two first transverse beams are fixed on the two first longitudinal beams through the first longitudinal adjustment fixing structure to adjust positions of the two first transverse beams on the two first longitudinal beams according to a length of the first support object so that first bracket component is capable of supporting the first support object with different lengths,
the first support object is an inverter.

3. The energy storage power foldable bracket according to claim 2, wherein each of the two first transverse beams is provided with a first transverse adjustment groove configured for a fixing component being inserted, and the first support object is fixed on the two first transverse beams through the fixing component;
a position of the fixing component on the first transverse adjustment groove is adjusted according to a width of the first support object, so that the first bracket component is capable of supporting the first support object with different widths.

4. The energy storage power foldable bracket according to claim 1, wherein the second bracket component comprises two second longitudinal beams arranged at intervals, and two second transverse beams arranged at intervals, each of the two second transverse beams is provided with a plurality of limit pieces arranged at intervals, and the second support object is supported on the second bracket component and limited between the plurality of limit pieces in forward-backward, and/or left-right manner;
each of the two second transverse beams is provided with a second longitudinal adjustment groove, and the plurality of limit pieces are provided with a second longitudinal adjustment fixing structure;
the second longitudinal adjustment fixing structure is capable of being inserted into the plurality of limit pieces and the second longitudinal adjustment groove;
the plurality of limit pieces are slid back and forth on the two second longitudinal beams through the second longitudinal adjustment fixing structure and the second longitudinal adjustment groove;
the plurality of limit pieces are fixed on the two second longitudinal beams through the second longitudinal adjustment fixing structure to adjust positions of the plurality of limit pieces on the two second longitudinal beams according to a length of the second support object, so that the second bracket component is capable of supporting the second support object with different lengths;
the second support object is a power supply.

5. The energy storage power foldable bracket according to claim 4, wherein each of the two second transverse beams is provided with a second transverse adjustment groove, each of the two second longitudinal beams is provided with a transverse adjustment fixing structure, the transverse adjustment fixing structure is capable of being inserted into the two second longitudinal beams and the second transverse adjustment groove,
the two second longitudinal beams are slid back and forth on the two second transverse beams through the transverse adjustment fixing structure and the second transverse adjustment groove, and the two second longitudinal beams are fixed on the two second transverse beams through the transverse adjustment fixing structure to adjust positions of the two second longitudinal beams on the two second transverse beams according to a width of the second support object so that the second bracket component is capable of supporting the second support object with different widths.

6. The energy storage power foldable bracket according to claim 4, wherein the plurality of limit pieces comprise an adjustment seat connected with the second longitudinal adjustment fixing structure,
the adjustment seat is provided with a first limit block, one end of the first limit block is provided with a second limit block;
the second support object is limited between the plurality of limit pieces by the first limit block and/or the second limit block in forward-backward and/or left-right manner,
a limit groove is formed between the first limit block and the second limit block of the plurality of limit pieces to limit a placement of the second support object.

7. The energy storage power foldable bracket according to claim 1, wherein the plurality of telescopic rod components comprise a fixed rod hinged to the first bracket component, and a movable rod connected to the second bracket component;
the fixed rod is provided with a telescopic cavity and a plurality of adjustment fixing positions at different positions, and the adjustment fixing positions are communicated with the telescopic cavity;
the movable rod is provided with a groove chamber configured to accommodate and install a telescopic adjustment locking piece;
the telescopic adjustment locking piece comprises a first shrapnel and a first pin provided on the first shrapnel;
the movable rod is provided with an insertion hole communicated with the groove chamber;
one end of the first shrapnel is elastically abutted against the groove chamber, and the first pin is extended out of the insertion hole through the other end of the first shrapnel;
when the movable rod is inserted into the telescopic cavity of the fixed rod, the first pin is pressed and retracted into the groove chamber of the movable rod, after the movable rod is inserted into a corresponding position, the insertion hole corresponds to one of the adjustment fixing positions,
the first pin is extended out of the insertion hole and the adjustment fixing positions under an action of the first shrapnel, so that the movable rod is fixed on the fixed rod.

8. The energy storage power foldable bracket according to claim 1, wherein a rotating connection component is provided between the first bracket component and the plurality of telescopic rod components,
the rotating connection component comprises a first connection piece fixedly connected to the first bracket component, and a second connection piece fixedly connected to the plurality of telescopic rod components,
the second connection piece is rotatably connected to the first connection piece through a rotation shaft;
the first connection piece is provided with an angle adjustment groove, and the angle adjustment groove is provided with an angle adjustment locking piece;
the second connection piece is rotated on the first connection piece through a rotation shaft,
one end of the angle adjustment locking piece is inserted into the angle adjustment groove and abutted against the second connection piece to fix the second connection piece that has been rotated on the first connection piece.

9. The energy storage power foldable bracket according to claim 1, wherein each of the plurality of telescopic rod components comprises a movable rod, the second bracket component comprises a second transverse beam,
the second transverse beam is provided with a clamp slot and a fixed hole,
the movable rod is provided with a groove chamber configured to accommodate and install a limit shaft and an elastic fastener;
the movable rod is provided with a perforation configured for the limit shaft being inserted;
the elastic fastener comprises a second shrapnel, and a second pin provided on the second shrapnel,
one end of the second shrapnel abuts against the groove chamber, and the movable rod is provided with a connection hole;
when the second bracket component is provided on the plurality of telescopic rod components, the clamp slot of the second transverse beam is supported on the limit shaft; the second pin is extended through the connection hole and the fixed hole through the other end of the second shrapnel so as to fix the second transverse beam of the second bracket component on the movable rod of the plurality of telescopic rod components;
when disassembling the second bracket component and the plurality of telescopic rod components, the second pin is put into the connection hole by pressing the second pin, and the clamp slot of the second transverse beam is disengaged from the limit shaft so as to achieve a disassembly of the second bracket component on the plurality of telescopic rod components.

10. The energy storage power foldable bracket according to claim 1, wherein a bottom of each of the plurality of telescopic rod components is provided with a caster.
